(19) United States
(12) Patent Application Publication
(10) Pub. No.: US 2015/0298139 A1
(43) Pub. Date: Oct. 22, 2015

(54) Device For Separating Out Magnetizable Impurities From Flowing Fluids

(71) Applicant: Stefan Wilkes, Mittelbiberach (DE)

(72) Inventor: Stefan Wilkes, Mittelbiberach (DE)

(73) Assignee: Norbert Ruez GMBH & Co. KG, Bad Schussenried (DE)

(21) Appl. No.: 14/410,430

(22) PCT Filed: Jun. 22, 2012
(86) PCT No.: PCT/EP2012/062103

§ 371 Date: Dec. 22, 2014

(51) Int. Cl. B03C 1/28

(52) U.S. Cl. CPC B03C 1/284; B03C 1/286; B03C 2201/18

(57) ABSTRACT

The invention relates to a device for separating out magnetizable impurities from flowing fluids (liquids or gases), comprising a cylindrical chamber (2) with an inlet (18) (fluid inlet) for the fluid carrying the magnetizable particles, an outlet (22) for the cleaned fluid (clean fluid outlet) and an outlet (28, 38) for the magnetizable particles (particle outlet). An internal pipe (4) that forms, together with the chamber wall, an annular gap (12) through which the fluid flows is arranged in the chamber (2). A supply valve (20) is located upstream of or at, the fluid inlet, and an outlet valve (30, 40) is provided at the particle outlet. At least one magnet (14, 36) is arranged outside said annular gap, between the fluid inlet and the cleaned fluid outlet in the direction of flow. A rotatable, helical scraper (10) is located in the annular gap (12), which scraper transports magnetizable particles which have deposited on the chamber wall and/or the internal pipe to the particle outlet (28, 38). A drive (8) is provided for the helical scraper (10) during the period of filter cleaning.

The present invention relates to a device for separating out magnetizable impurities from flowing fluids (liquids and gases).

Magnetic filters are used for removing magnetizable particles from fluids which accumulate e.g. during manufacture (e.g. metal cuttings during drilling and turning). Attempts are made to achieve the highest possible filter efficiency, in particular also the removal of very small particles, in order to reduce the wear on machines and tools through which the fluids flow or which come into contact with said fluids. During operation of the magnetic filter, more and more magnetizable filter particles are deposited on the wall or surface. The filter efficiency thus decreases gradually and in the worst case scenario the filter becomes clogged. Therefore, the magnetic filter must be cleaned at time intervals in which the filtration operation is interrupted for the shortest possible period of time.

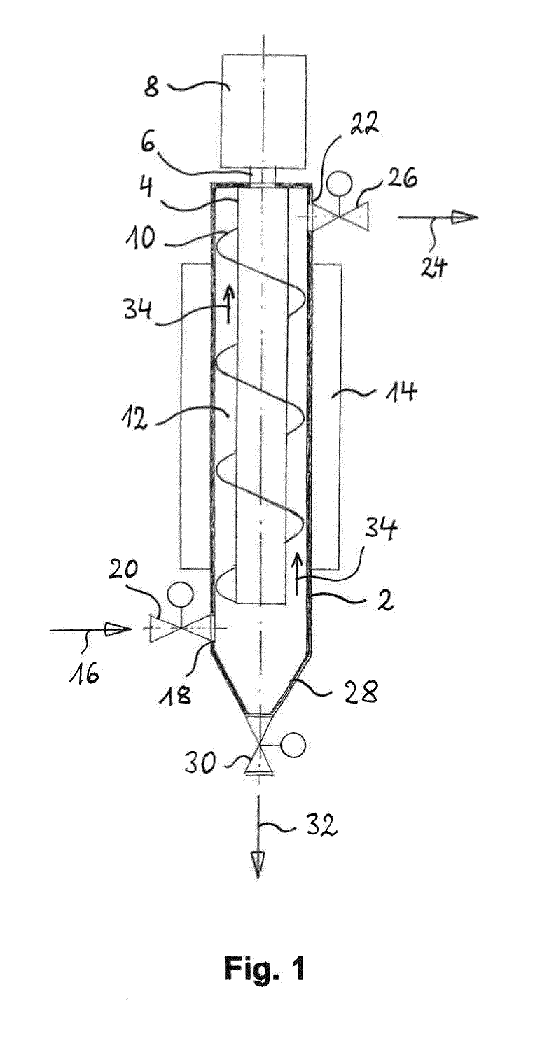

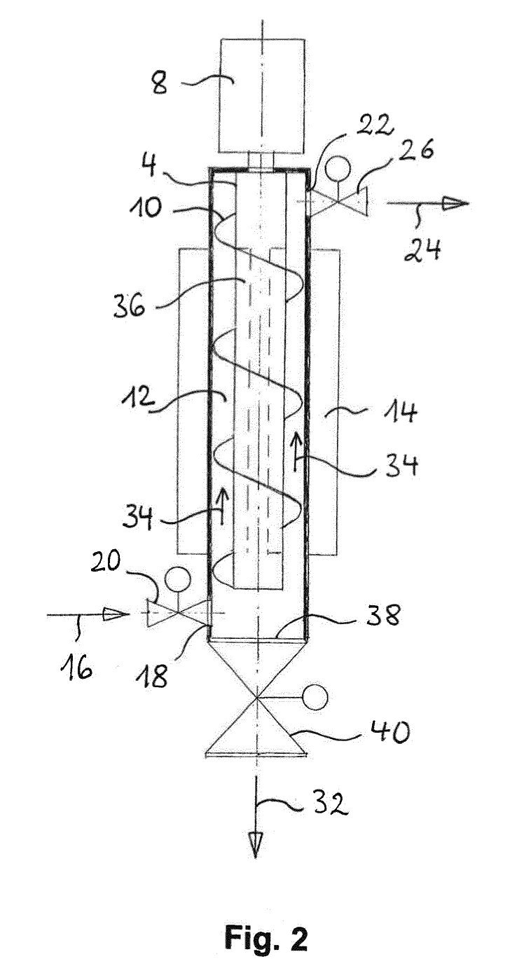

DE 1 160 130 A describes a device for magnetic filtering of magnetically conductive particles from flowing media. In a vertical pipe or housing 1, which is magnetically induced, a screw 2 is mounted so as to be rotatable about a spindle 3, 6 and strips and removes impurities, which are deposited on the wall, leaving only a thin layer. Continuous cleaning is presented as a possible alternative. In the case of the exemplified embodiment of FIG. 1, the liquid flows from top to bottom and, as the liquid flows through the screw channels, centrifugal forces are produced which are used for cleaning purposes. The particle outlet and the outlet for the cleaning liquid are located below the contaminated screw. There is the risk that impurities will pass into the cleaned liquid. The polarity of the magnets is ineffective as the greatest magnetic forces are always present at the poles of the magnet, see below. In the case of the exemplified embodiment of FIG. 2, the liquid flows through a rotating hollow spindle 6 and through the holes thereof into the pipe, wherein the tangential exit from the hollow spindle assists the cleaning effect, and in this case, by rotating the screw, the impurities are discharged upwards and transported to the poles, where the magnetic forces are at their greatest. By reason of the design, the magnetizable particles can only be urged away by impurities which are pushed behind them. Depending upon the characteristic of the magnetizable particles, the area between the cover plate and the magnet becomes clogged.

A magnetic filter device which is known from DE 1 794 280 B comprises a cylindrical housing 1 having an inlet opening 2 and an outlet opening 3. In the housing 1, a rotatable magnetic filter column having magnets 5, 6 is arranged concentrically in such a manner as to be able to rotate on a non-magnetic shaft 7. Located between the inlet 2 and the magnetic filter column is a cylindrical, non-magnetic cover shell 9 which in the case of the exemplified embodiment of FIG. 4 comprises screw flights 16. Located in the entry region (accumulation region 13) is a capturing or scraping strip 14 which during rotation of the magnetic column scrapes off the impurities deposited thereon. The adhering magnetic impurities can be cleaned from the magnetic filter during normal filter operation. A rotary drive which operates periodically can also be provided. In the case of the known magnetic filter, there is the risk that slurry will be produced on the outer side of the cover shell 9. At this location, magnetic forces are still effective when strong magnets are used. These forces are particularly high if the rigidly attached screw flights are filled with slurry, since the magnetic forces are transmitted through the ferromagnetic particles. Since the magnetic column 5, 6 is arranged centrally, the effective surface for capturing the magnetizable particles is smaller than with a peripheral arrangement. In addition, the magnet(s) is/are located in the medium and this can lead to a stability problem in relation to the magnetic material because some magnetic materials dissolve in certain media.

A magnetic separator for removing magnetizable metal parts from a paper fiber suspension in accordance with DE 103 31 022 A1 comprises a cylindrically formed magnet 1 which is driven by a drive shaft 6. A part is surrounded by a coaxial pipe 7, in which a helical screw, which surrounds the magnet, is located as a conveying element 2. Instead of the combination of a rotating magnet and a stationary conveying element, the magnet can also be stationary and the conveying element rotates. The relative movement serves to produce an axial conveying movement, whereby the particles which are firmly held by means of the magnet are conveyed out. The outward conveyance can be continuous or can be performed at time intervals. In the case of this magnetic separator, relatively coarse ferromagnetic particles are separated out. The filtrate does not flow through the screw helixes and the separating process takes place only outside the pipe 7 but not inside it. In the pipe 7, the ferromagnetic particles together with a proportion of paper fibers are transported for discharge or to the trap 4 and in this case the magnet has only a conveying function. The fiber proportion can be flushed back through the flush connection 13.

The object of the invention is to provide a device for separating out magnetizable impurities from flowing fluids (liquids and gases), which device operates in an energy-efficient manner, can handle large quantities of impurities and can be cleaned with minimum interruption to the throughflow of fluid.

In accordance with the invention, this object is achieved in the case of a device for separating out magnetizable impurities from flowing fluids having the features of claim 1. Advantageous developments of the device in accordance with the invention are described in the dependent claims.

The invention thus relates to a device for separating out magnetizable impurities from flowing fluids (liquids or gases), which device contains a cylindrical chamber having an inlet (fluid inlet) for the fluid which contains magnetizable particles, an outlet for the cleaned fluid (clean fluid outlet) and an outlet for the magnetizable particles (particle outlet). Arranged in the chamber is an inner cylinder body which together with the chamber wall forms an annular gap through which the fluid flows. A supply valve is located upstream of or at the fluid inlet and an outlet valve is provided at the particle outlet. At least one magnet is arranged outside the annular gap between the fluid inlet and the clean fluid outlet in the direction of flow. Located in the annular gap is a rotatable, helical scraper which transports magnetizable particles deposited on the wall of the chamber and/or the inner pipe to the particle outlet. A drive for the helical scraper during the period of filter cleaning is provided.

The device in accordance with the invention for separating out magnetizable impurities, in particular ferromagnetic particles, from fluids is characterized by a very simple structure. It filters the magnetizable particles from flowing liquids or gases, wherein the throughflow is produced by negative pressure or overpressure. The liquids can be e.g. emulsions, cutting oils or the like and the particles can be ferromagnetic particles consisting of iron or steel. However, other liquids can also be cleaned and the particles can also be paramagnetic. The device in accordance with the invention is also suitable for cleaning gases of magnetizable particles and e.g. metallurgical dust can be removed from the air. Particles with dimensions of less than 10 μm can be separated out.

The magnetic filter in accordance with the invention is thus characterized by the property of being self-cleaning. Its mode of operation is as follows: liquid (or gas) to be cleaned flows through the annular gap during normal operation. Located in the annular gap is the helical guiding device for the liquid, whereby the liquid is subjected to a centrifugal force and attempts to reach the outer wall. The helical guiding device is designed to be rotatable for cleaning and scrapes solid particles (slurry), which have remained adhered during the period of cleaning, off the outer wall. During filtering, the helical guiding device is not driven. The cleaning procedure takes place without pressure, i.e. no pressure has to be additionally built up. Rather, back-flushing is optionally performed or the existing overpressure is used, which will also be described hereinafter.

The magnets can be permanent magnets or electromagnets. Preferably, the magnet(s) is/are attached externally to the cylindrical chamber. On the one hand, in the case of this arrangement the effective surface for collecting the magnetizable particles is larger. On the other hand, the magnets can be replaced during operation or further magnets can be attached. The helical scraper can then be attached to the inner cylinder body, e.g. it can be welded thereto, wherein the inner cylinder body is then designed to be rotatable.

In addition, magnets can be provided inside the annular gap, e.g. in order to increase the forces, which act upon the magnetizable particles, and thus the filter efficiency. In this case, the helical scraper is always designed to be able to rotate independently of the chamber wall and the inner cylinder body and thus has a separate drive.

By means of the helical scraper in the annular gap, the fluid is guided in a helical manner through the annular gap. In the case of externally attached magnets, the centrifugal forces acting upon the magnetizable particles as the fluid flows through the screw helix assist the movement of the particles outwards to the chamber wall. If the pitch of the screw helixes is selected to be shallow, the flow resistance increases. At the same time, the magnetizable particles remain longer in the magnetic field and are separated out from the fluid more efficiently by reason of the longer dwell time. A further parameter, by which the filter function can be controlled, is the gap width which likewise influences the flow rate. Therefore, it is possible to control the separating behavior in relation to the particle size. If larger particles are to be separated out, the flow rate is increased, and vice versa. Still further parameters which affect the cleaning behavior are the throughflow of the inflowing fluid, the viscosity thereof and the strength of the magnets used or of the magnetic fields.

The particle outlet is provided in an expedient manner in the region of the chamber, in which the fluid inlet is located. The clean fluid is thus discharged in the opposite direction to the extracted magnetizable particles. By means of this measure, fewer dirt particles remain in the filtrate.

Depending upon the cleaning behavior of the magnetizable particles, the particle outlet is funnel-shaped or cylindrical.

By opening the discharge valve, the magnetizable particles which are scraped off by the scraper and transported to the particle outlet can be flushed or cleaned with the aid of the overpressure present in the system.

In the case of one embodiment of the device in accordance with the invention, the clean fluid outlet is equipped with an automatic valve. If this valve is closed, the liquid can all be urged through the particle outlet by the existing overpressure, in order, in critical cases, to transport the impurities out of the chamber in a reliable manner.

Flushing can also be performed from the clean liquid side. For this purpose, the supply valve is closed. Then, by reason of the overpressure in the system the liquid is discharged, together with the impurities, through the particle outlet.

It is possible to clean the magnetic filter even during operation. For this purpose, a restrictor is installed into the clean fluid outlet. However, in this embodiment, as the magnetic filter is being cleaned the flow rate is reduced for a short period of time and the pressure of the filtrate is decreased.

In order to ensure continuous operation even during filter cleaning, two magnetic filters can be arranged in parallel. In this case, a switching device is then provided for switching from a fluid inlet of one magnetic filter to the fluid inlet of the other magnetic filter (e.g. a three-way valve) and/or opening and closing the allocated clean fluid outlets. If the magnetic filter in operation has to be cleaned, a switch is made to the other magnetic filter. The cleaning process does not cause either an interruption to the operation of the entire installation or a decrease in fluid pressure.

A further alternative for cleaning the device in accordance with the invention, in which the extracted particles are separated from the fluid, can be used in the embodiment having a cylindrical particle outlet. It is arranged at the particle outlet or downstream thereof and is provided with a deflector or a corresponding additional device, which performs a switch at the particle outlet to a discharge of fluid and solids. At the beginning of the cleaning procedure, the liquid present in the chamber is firstly drained off. To this end, the discharge valve is opened and the supply valve and the valve at the clean fluid outlet are closed. After the fluid is drained off, the helical scraper is driven and strips off the dirt particles adhering to the wall. The wet solids, essentially the dry substance, exit the chamber through the particle outlet and can be discharged via a line or can be collected in a collection container. After this, post-flushing should be performed in order to extract the remaining detached dirt particles. A deflector can be used e.g. to discharge the solids into the collection container and the liquid, which is let out of the chamber, via a separate line. With a high slurry concentration (particle proportion in the fluid), the fluid and solid should not be separated, instead both should be discharged together in order to avoid clogging.

In the case of another embodiment of the device in accordance with the invention, the clean fluid is let out into a tank. In this case, no counter pressure is present at the chamber on the clean fluid side.

The invention will be described further hereinafter with the aid of preferred exemplified embodiments and the drawing, wherein this illustration, like the summary of features in the dependent claims, is not intended to limit the invention but rather serves merely for illustrative purposes. In the drawing:

FIG. 1 shows a schematic view of a magnetic filter in accordance with a first exemplified embodiment of the invention comprising magnets arranged outside the annular gap, and

FIG. 2 shows a schematic view of a magnetic filter in accordance with a second exemplified embodiment of the invention comprising magnets arranged outside and inside the annular gap.

A first exemplified embodiment of the invention will be described hereinafter with the aid of FIG. 1; it is a magnetic filter for separating out ferromagnetic impurities from liquids, such as emulsions or cutting oils. In the case described, the magnetic filter is fitted in an installation, in which the liquid is conveyed with overpressure, such as prevails e.g. in pump systems. The magnetic filter comprises a cylindrical chamber 2 which is illustrated in a vertical position. An e.g. horizontal arrangement of the chamber is likewise possible. The chamber wall is made of non-ferromagnetic material, preferably high-grade steel or synthetic material. Located in the chamber 2 is an inner cylinder head 4 which is coupled to a motor 8 via a pivot pin 6. The inner cylinder head can be solid or can be hollow on the inside. In the case of the exemplified embodiment of FIG. 1, it is hollow on the inside and is designated hereinafter as an inner pipe. Attached to the outside of the inner pipe 4 is a scraper 10, a screw helix, which extends almost to the wall of the chamber 2. The inner pipe 4 extends over virtually the entire length of the chamber 2 and terminates at a spaced interval short of its end which is opposite to the motor 8, i.e. the lower end in FIG. 1. The inner pipe 4 and the wall of the chamber 2 define an annular gap 12. Arranged on the outside of the chamber 4 is a magnet 14, the magnetic field of which passes through the annular gap 12.

In the illustration of FIG. 1, located at the bottom of the chamber 2 is an inlet 18 for contaminated liquid which contains ferromagnetic particles, see arrow 16. The inlet 18 is provided with a supply valve 20. At the top in FIG. 1, i.e. at the end of the chamber 2 close to the rotary spindle 6 there is located an outlet 22 for clean liquid, see arrow 24. The outlet 22 is provided with an automatic valve or a restrictor valve 26. An outlet 28 for the ferromagnetic particles (slurry outlet), see arrow 32, is located at the end of the chamber 2, which is opposite to the clean liquid outlet 22, is below the inlet 18 in FIG. 1 and is funnel-shaped in design. It is provided with an outlet valve (slurry outlet valve) 30.

The magnetic filter can be retrofitted in existing installations. During normal operation, contaminated liquid which contains ferromagnetic particles (e.g. cutting emulsion with metal cuttings) flows through the inlet 18 into the chamber 2. The liquid then passes into the annular gap 12 and flows therethrough being guided by the helixes of the screw helix 10, see arrow 34. Under the effect of the magnetic field produced by the magnet 14, the ferromagnetic particles migrate outwards to the wall of the chamber 2 where they are deposited. The clean liquid exits at the end of the chamber 2 through the outlet 22. The slurry outlet valve 30 is closed during normal operation.

If the ferromagnetic particles accumulating on the chamber wall are to be cleaned from the magnetic filter, the supply valve 20 and, in the embodiment of the outlet valve 26 as an automatic valve at the clean liquid outlet 22, the outlet valve are closed. When a restrictor valve is present, it is moved to the restricting position, so that less clean liquid issues out of the magnetic filter. The slurry outlet valve 30 is opened. The motor 8 is switched on and rotates the inner pipe 4 with the screw helix 10. The latter scrapes or scratches the particles off the chamber wall. The direction of rotation is selected such that the particles are transported by the screw helix 10 in the direction of the slurry outlet 28. If the screw helix 10 is not sufficient or if there is the risk that the slurry outlet 28 will become choked by the particles, the supply valve 20 can be opened and incoming dirty liquid can be used to flush out the ferromagnetic particles through the slurry outlet 28. The cleaning procedure does not require very much time, which means that the interruption to the operation of the installation is short.

FIG. 2 shows a second exemplified embodiment in accordance with the invention. Where the parts are identical to those of the first exemplified embodiment, they will be designated by the same reference numerals and will not be described once again. In the case of the magnetic filter illustrated in FIG. 2, magnets 36 are also arranged in the inner pipe 4. The screw helix 10 is not attached to the inner pipe 4 but instead can be driven directly by the motor 8. It strips particles, which are deposited during filter cleaning, both off the chamber wall and off the inner pipe. The slurry outlet 38 is cylindrical, thus reducing the risk of clogging. The slurry outlet 38 is provided with an outlet valve 40.

The cylindrical design is independent of the location of the arrangement of magnets, i.e. whether they are arranged on the outside or on the inside. In the case of a horizontal chamber arrangement, a cylindrical particle outlet is preferred.

1. A device for separating out magnetizable impurities from flowing fluids, comprising:
a cylindrical chamber having a chamber wall, an inlet for fluid containing magnetizable particles, an outlet for cleaned fluid and an outlet for the magnetizable particles, wherein disposed in the chamber is an inner cylinder body which together with the chamber wall forms an annular gap through which the fluid flows,
a supply valve upstream of or at the fluid inlet,
an outlet valve at the particle outlet,
at least one magnet disposed outside the annular gap between the fluid inlet and the cleaned fluid outlet in the direction of flow,
a rotatable, helical scraper disposed in the annular gap to transport magnetizable particles deposited on the wall of the chamber and/or the inner pipe to the particle outlet, and
a drive for the helical scraper during filter cleaning.

2. The device as claimed in claim 1, wherein the helical scraper is seated on the inner cylinder body and can be rotated together therewith.

3. The device as claimed in claim 1, wherein at least one further magnet is attached in the inner cylinder body.

4. The device as claimed in claim 1, wherein the helical scraper drive solely drives the helical scraper.

5. The device as claimed in claim 1, wherein the particle outlet is provided in a region of the chamber, in which the fluid inlet is located.

6. The device as claimed in claim 1, wherein the particle outlet is funnel-shaped.

7. The device as claimed in claim 1, wherein the particle outlet is cylindrical.

8. The device as claimed in claim 7, wherein a switchable deflector or fork for discharging fluid and particles in each case is provided at or downstream of the particle outlet.

9. The device as claimed in claim 1, wherein the clean fluid outlet is equipped with an automatic valve.

10. The device as claimed in claim 1, wherein the clean fluid outlet is equipped with a restrictor.

11. The device as claimed in claim 1, further comprising, in combination, a second said device arranged in parallel therewith and a three-way valve provided for switching from a fluid inlet of one said device to the fluid inlet of the other said device.

12. A device for separating out magnetizable impurities from flowing fluids, comprising:
a cylindrical chamber having a fluid inlet for the fluid containing magnetizable particles, a clean fluid outlet for the cleaned fluid after particle separation and a particle outlet for the separated magnetizable particles, said chamber, inlet and outlet configured to produce flow therethrough in response to an applied pressure;
an inner cylinder body disposed in the cylindrical chamber to form an annular gap between said cylinder body and cylindrical chamber through which the fluid flows by said pressure from the inlet to the outlet;
at least one magnet disposed outside said annular gap between the fluid inlet and the clean fluid outlet;
a rotatable, helical scraper disposed in said annular gap for transporting magnetizable particles deposited on walls defining the annular gap to the particle outlet;
a fluid supply valve positioned to control flow to the fluid inlet, said supply valve having a normally open position corresponding to helical scraper not rotating and a closed, cleaning position corresponding to rotation of the helical scraper; and
a particle outlet valve disposed at the particle outlet, said particle outlet valve having a normally closed position corresponding to the helical scraper not rotating and an open, cleaning position corresponding to rotation of the helical scraper.

13. The device as claimed in claim 12, wherein the helical scraper is attached to the inner cylinder body and is rotatable therewith.

14. The device as claimed in claim 12, wherein at least one further magnet is attached in the inner cylinder body.

15. The device as claimed in claim 12, wherein the cylindrical chamber has a first end and an opposite second end, the particle outlet and the fluid inlet disposed at said first end and fluid outlet disposed at said opposite second end.

16. The device as claimed in claim 12, wherein the particle outlet is funnel-shaped.

17. The device as claimed in claim 12, wherein the particle outlet is cylindrical and a switchable deflector or fork for discharging fluid and particles is provided at or downstream of the particle outlet.

18. The device as claimed in claim 12, wherein the clean fluid outlet is equipped with an automatic valve.

19. The device as claimed in claim 12, wherein the clean fluid outlet is equipped with a restrictor.

20. The device as claimed in claim 12, further comprising, in combination, a second said device arranged in parallel and a three-way valve cooperating therewith for switching from the fluid inlet of one said device to the fluid inlet of the other said device.
